(19) United States
(12) Patent Application Publication
(10) Pub. No.: US 2010/0056122 A1
(43) Pub. Date: Mar. 4, 2010

(54) REMOTE COMMUNICATION METHOD AND ITS MEETING SYSTEM

(76) Inventor: Zhongwen CHEN, Dongguan (CN)

Correspondence Address: SCIHEAD INTELLECTUAL PROPERTY LAW GROUP, LTD, Huihua Commercial & Trade Building, Suite 1508, 80 Xian Lie Zhong Road, Guangzhou, 51070, CN

(21) Appl. No.: 12/202,428

(22) Filed: Sep. 1, 2008

(51) Int. Cl. H04M 3/42

(52) U.S. Cl. 455/416

(57) ABSTRACT

The present invention provides a method for remote communication to realize the multi-user communication pattern, comprising: (1) linking at least one communication part of a plurality of communication devices via using expansion connection device; (2) connecting any plurality of communication devices of at least one communication part to communicate with communication devices of other parts by expansion connection device. In one embodiment of the invention, the method farther includes the step of recording contents of communication by record equipment. The method also comprises the step that any plurality of communication devices of at least one communication part converts communication signals by using expansion connection device before communicating to other parts. The present invention also provides one remote communication meeting system using the method for remote communication.

### FIELD OF THE INVENTION

The present invention relates to a method for remote communication and its meeting system. More particularly, the invention relates to a method for remote communication and its meeting system for many kinds of communication devices operating concurrently.

### BACKGROUND OF THE INVENTION

During people's daily life, there is no doubt that phone is a very important communication tool. Work, study or chat all can be reached by phone. When people handle the business with others at a distance, there is a great need for phone to avoid mistakes and complete their work smoothly.

However telephone conversation mostly is one to one. When facing complicate and multilayer business, multi parties are unable to communicate in time. It needs to dial or receive calls one after another, and thus people should communicate with others one by one. Accordingly, not only does it waste time and money, but also results in weak implement of work due to the error during conveying message.

With the development of technology, network conferencing system has been designed at present. People in different countries or areas can hold a conference to carry through the work. However, network need costly equipment and people who attend conference must go to certain place, and then start the conference after connection and ID confirmation. Accordingly, only can they dial or receive calls one by one when people come across problem outside in some place, and sometimes they could not settle the problem in real-time, and thereby it needs another conference to solve the problem after they return to the company.

To solve the foregoing problem, there is a great need to provide one remote communication method and its meeting system which surmount the defects of conversational technology.

### SUMMARY OF THE INVENTION

Due to the defects of conventional technology, one aspect of the present invention is to provide a method for remote communication, allowing relevant people to participate certain conference anywhere or anytime to improve the work efficiency and virtue.

Another aspect of the present invention is to provide a remote communication meeting system, allowing relevant people to participate certain conference anywhere or anytime to improve the work efficiency and virtue.

The other aspect of the present invention is to provide a remote communication meeting system, only when the conversation parts are far away, they need to dial and receive a call, while meeting parts at the same place can communicate with others by installing expansion connection device, and thereby it has a low cost and a good effect.

To achieve foregoing object, one method for remote communication of the Invention is to realize the multi-user communication pattern. The method includes such steps: (1) linking at least one communication part of a plurality of communication devices via using expansion connection device; (2) connecting any plurality of communication devices of at least one communication part to communicate with communication devices of other parts by expansion connection device.

In one embodiment of the invention, the said method further includes the step of recording contents of communication by record equipment. The method also comprises the step that any plurality of communication devices of at least one communication part converts communication signals by using expansion connection device before communicating to other parts.

The invention provides one remote communication meeting system, which comprises: communication device to dial or receive calls; at least one extension communication device to participate in the conversation of the said communication device; at least one expansion connection device arranged with one conversion apparatus in it, one side of which is coupled to earphone interface or linking port of the communication device, while the other side is coupled to earphone interface or linking port of extension communication device, and thereby the communication pattern for multi-user with single line is formed. In one embodiment, the expansion connection device can be coupled to many linking ports to communicate with more extension communication devices. The communication devices include telephones, wireless phones and mobile phones. The extension communication devices include telephone, recorder, codeless phone and mobile phone. In another embodiment, the extension communication devices could be computer. The expansion connection device comprises s earphone conversion apparatus, microphone arranged in interior of conversion apparatus, several linking points and plug. Linking points and plug are connected to conversion apparatus through extension cords, and earphone and conversion are also connected by extension cord. The extension communication devices can dial more calls, and thereby the communication pattern for multi-users with multi-lines can be formed through expansion connection device. With reference to the method of the invention, relevant people can participate in on-line conferences through telephone to complete the work anywhere or anytime.

Compared with conventional technology, through highly popular telephone network and expansion connection device with reference to remote communication method and its meeting system, people with telephone can participate in some conferences as needed to complete their job perfectly anywhere or anytime, and thereby it work rapidly with little cost.

To make the invention easier to understand, several particular embodiments of remote communication method and its meeting system thereof will now be described in detail with reference to the appended drawings in which.

### BRIEF DESCRIPTION OF THE DRAWING

FIG. 1 schematically shows an expansion connection device according to the invention.

FIG. 2 schematically shows the connection of many expansion connection devices according to the invention.

FIG. 3 schematically shows remote communication meeting system according to one embodiment of the invention.

FIG. 4 schematically shows remote communication meeting system according to another embodiment of the invention.

### DETAILED DESCRIPTION OF ILLUSTRATED EMBODIMENTS

To achieve foregoing object, one method for remote communication of the Invention is to realize the multi-user communication pattern. The method includes such steps: 1, use expansion connection device to link a plurality of communication devices of at least one communication part. 2, and through expansion connection device connect the said any plurality of communication devices of at least one communication part to communicate with communication devices of other parts.

In one embodiment of the invention, the said method further includes the step of recording contents of communication by record equipment. Before the communication to other parts, the said any plurality of communication devices of at least one communication part also includes conversion of communication signals by using expansion connection device.

The invention provides one remote communication meeting system, which comprises: communication device to dial or receive calls; at least one extension communication device to participate in the conversation of the said communication device; at least one expansion connection device arranged with one conversion apparatus in it, one side of which is coupled to earphone interface or linking port of the communication device, while the other side is coupled to earphone interface or linking port of extension communication device.

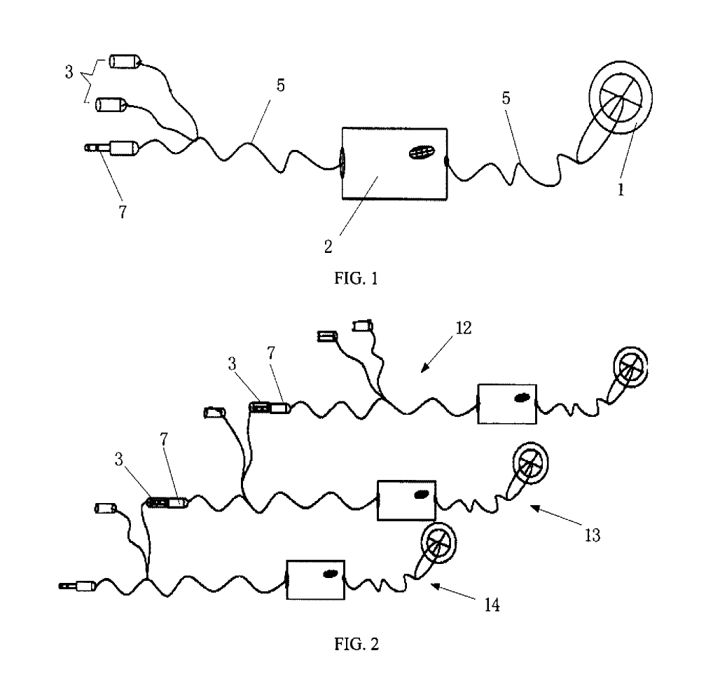

As shown in FIG. 1, the expansion connection device according to one embodiment of the invention comprises earphone1, conversion apparatus 2, microphone arranged in interior of conversion apparatus2(not shown in drawings), several linking points3 and plug7. Among them, linking points3 and plug7 are connected to conversion apparatus2 through extension cords5 and earphone1 and conversion 2 are also connected by extension cord5. The said linking point3 and plug7 can be inserted into linking port of electronic apparatus or communication devices, which are thereby connected with expansion connection device. As the said linking point3 are plural, the said expansion connection device can still connect other expansion connection devices to provide a communication function after providing the function of earphone-microphone. So the communication pattern for multi-user through one line can be achieved by the expansion connection device.

Referring to FIG. 2, in one embodiment of the invention, the said expansion connection device can be used interconnectedly except using by itself. For example, expansion connection device12 can be connected with expansion connection device13 by inserting plug7 thereon into linking point3 thereof; In the same way, expansion connection device13 can be connected with expansion connection device14 by inserting plug7 thereon into linking point3 thereof; Thus the expansion connection device 12, 13, 14 are interconnected together.

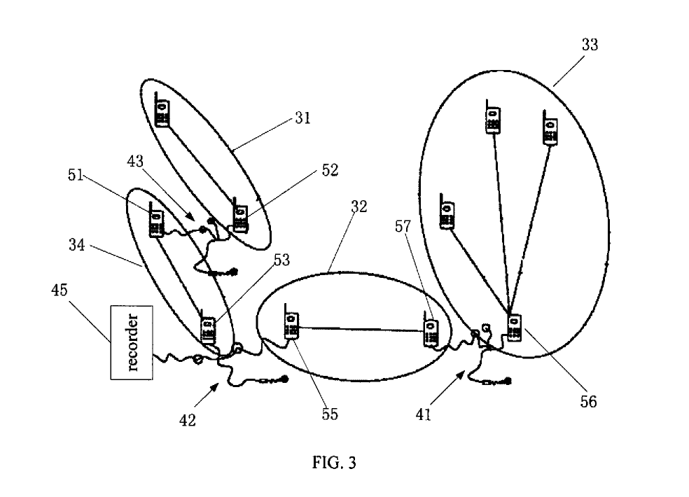

FIG. 3 is one schematic view of remote communication meeting system of one embodiment of the invention. In the embodiment, system31, 32, 33, 34 are assumed to be wireless communication system. Just linking mobilephone52 in wireless communication system 31 and mobilephone51 in wireless communication system 34 through expansion connection device43 can connect wireless communication system 31 and 34. Just linking mobilephone53 in wireless communication system 34 and mobilephone55 in wireless communication system 32 through expansion connection device42 can connect wireless communication system 34 and 32. Wireless communication system 34 and 32 can get connected just by linking mobilephone57 in wireless communication system 32 and mobilephone56 in wireless communication system 33 through expansion connection device41. If wireless communication system33 is originally formed multi-part communication system, the communication pattern for multi-users with multi-lines can be formed as expansion connection device43, 42, 41 bring communication devices in wireless communication system31, 32, 34 into communication process of wireless communication system33 Of course, by further connecting the said system31, 32, 33, 34 with other communication devices through expansion connection device, then getting through more users by extension telephones makes the meeting communication have a unlimited expansion capacity of participants. Thus, all mobile phones in the system can communicate with each other to get network of different corporations interconnected, and call charges can be reduced or for free in the same network according to existed communication market, so multi-user communication and low communication cost can be achieved at the same time. In the embodiment, the said expansion connection device(such as expansion connection device42) also can make record by connecting with recorder 45.

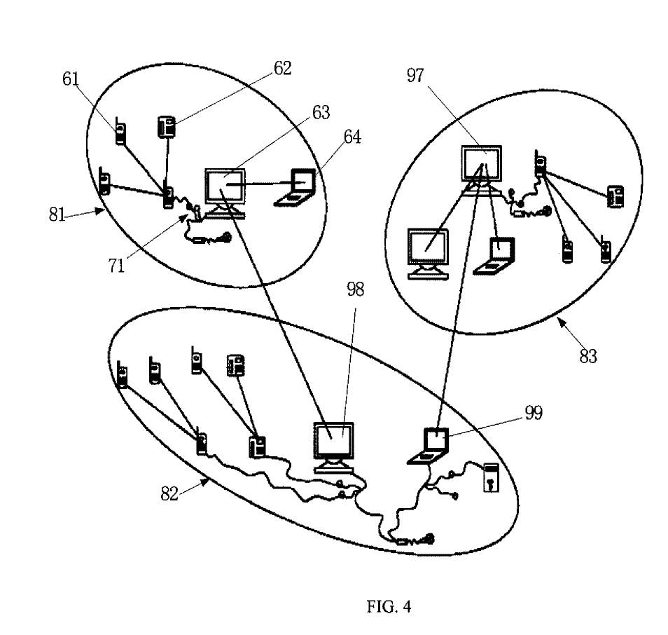

FIG. 4 is another schematic view of remote communication meeting system of the embodiment of the invention. In the embodiment, the said system81, 82, 83 are all concurrently operated with many kinds of communication devices. Taking system 81 as one example, one expansion connection device can connect mobile phone 61, fixed telephone62, pc63 and laptop64. The said system81 and system82 connects network between pc63 and 98; while the said system82 and system83 connects network between pc97 and laptop99; Thus a big amount of international long-distance call charge can be saved when multiform communication devices are used together and communicated among multi-users, especially in communication of the same network in different countries.

In the present invention, the amount of the above-mentioned remote communication method and expansion connection device depends on requirement, as well as the amount of the electronic apparatus or communication devices.

The above-mentioned remote communication method and its meeting system of the invention utilizes the common use of mobile phone in modern society, relevant people can participate in discussion of one meeting at any time and any place and make a decision in time to improve the work efficiency and virtue. And only when the conversation parts are far away, they need to dial and receive a call, while meeting parts at the same place can communicate with the people dialing or receiving a call by installing expansion connection device, the meeting will have a low cost and a good effect.

The foregoing description is only preferred embodiment of remote communication method and its meeting system of the invention; the scope of claim is certainly not limited to the described. The invention is, therefore, claimed in any of its forms or modifications within the proper scope of the appended claims appropriately interpreted in accordance with the doctrine of equivalents.

What is claimed is:

1. A method for remote communication to realize the multi-user communication pattern, comprising the steps of:
linking at least one communication part of a plurality of communication devices via using expansion connection device;
connecting any plurality of communication devices of at least one communication part to communicate with communication devices of other parts by expansion connection device.

2. The method for remote communication according to claim 1, wherein said method further includes the step of recording content of communication by record equipment.

3. The method for remote communication according to claim 1, before the communication to other parts, the any plurality of communication devices of at least one communication part also includes conversion of communication signals by using expansion connection device.

4. A remote communication meeting system, comprising:
communication device to dial or receive calls;
at least one extension communication device to participate in the conversation of the said communication device;
at least one expansion connection device arranged with one conversion apparatus in it, one said of which is coupled to earphone interface or linking port of the communication device, while the other side is coupled to earphone interface or linking port of extension communication device.

5. The remote communication meeting system according to claim 4, wherein said expansion connection device can be coupled to several linking ports to communicate with more extension communication devices.

6. The remote communication meeting system according to claim 5, wherein said communication device is telephone, wireless phone or mobile phone; said extension communication device is telephone, recorder, codeless phone, computer or mobile phone.

7. The remote communication meeting system according to claim 6, wherein said expansion connection device comprises earphone, microphone arranged in interior of conversion apparatus, several linking points and plugs, said linking points and said plugs connect with conversion apparatus through extension cords, and earphone connects with conversion device by extension cord.

8. The remote communication meeting system according to claim 7, wherein the extension communication devices can dial other calls, and thereby the communication pattern for multi-user with multi-line can be formed through expansion connection device
